(19) United States
(12) Patent Application Publication
(10) Pub. No.: US 2018/0163512 A1
(43) Pub. Date: Jun. 14, 2018

(54) WELL TREATMENT

(71) Applicant: Schlumberger Technology Corporation, Sugar Land, TX (US)

(72) Inventors: Courtney Payne, Stafford, TX (US); Mohan Kanaka Raju Panga, Sugar Land, TX (US); Jesse Lee, Sugar Land, TX (US); Yenny Christanti, Houston, TX (US); Ziad Al-Jalal, Dammam (SA)

(21) Appl. No.: 15/378,600

(22) Filed: Dec. 14, 2016

(51) Int. Cl. E21B 37/00; C09K 8/74; C09K 8/52

(52) U.S. Cl. CPC E21B 37/00; C09K 2208/08; C09K 8/52; C09K 8/74

(57) ABSTRACT

Methods of treating formation damage or other service induced damage in a near wellbore region of a wellbore of a subterranean formation, by treating a zone or zones in the near wellbore region, and diverting treatment fluid stages from the treated zones to untreated zone(s) with an acid precursor material and optionally also with fibers. The acid precursor material has an average particle size less than 1000 microns.

### BACKGROUND

The statements in this section merely provide background information related to the present disclosure and may not constitute prior art.

Some embodiments relate to methods applied to a well bore penetrating a subterranean formation.

Hydrocarbons (oil, condensate, and gas) are typically produced from wells that are drilled into the formations containing them. For a variety of reasons, contact between the reservoir and the wellbore can become blocked, restricting the flow of hydrocarbons into the well or the well injectivity into the formation. This can be caused by formation damage or other induced damages. Types of near wellbore formation damage can come from many sources including but not limited to clays, fines, precipitates and scales (both organic and inorganic), emulsions, filter cakes (both water and oil based), alterations in the rock wettability, the introduction of an immobile phase, water blocks, condensate blocks, and thick oils. Near wellbore damage (skin) can occur either on top of the formation or in the top layer of the matrix closest to the wellbore. Formation damages and other induced damages can be naturally occurring or service induced. In this case, the well is treated with a treatment fluid, which can include fluids for drilling mud removal, altering the rock wettability, removal of insoluble materials and clays, and the breaking of emulsions among other applications. Formation damage remediation treatments can be performed on more than one area of a well, within layers of varying height and permeability. The goal of such treatments is to ensure successful reduction of damage along the entire interval of interest. However, due to heterogeneities along the wellbore, the treatment fluid will not contact the entire interval. A diverter can be used between treatment fluid stages to temporarily restrict access to more permeable zones and achieve better treatment coverage of the wellbore. To divert a treatment fluid, either mechanical (packers, etc.) and/or chemical methods may be used. The diverter must eventually degrade or be removed to allow the treated zones to communicate with the wellbore.

As an added complexity, treatments performed with coiled tubing require that diverting materials must be able to pass through the coiled tubing string, which may contain a complex flow path, very small exit points, or other constrictions, and/or instruments sensitive to fluid friction or drag. For example, a small deposition of even a partial plug in a coiled tubing string might impose sufficient drag on a distributed sensor cable to stretch or break it and ruin the cable. These limitations create an environment that limits the applicability of many diverting materials for delivery through coiled tubing.

As a further complexity, there are difficulties in employing chemical diverting materials in conjunction with inflow control devices (ICD's) and other mechanical sand control devices (screens, etc.), other completion devices, such as slotted liners, mechanical sleeves. This is because the diverting agents tend to accumulate on the ICD's or mechanical sand control devices rather than contact the formation directly and thus cannot adequately divert fluids away from the desired zone to be plugged. An ICD is a passive component installed as part of a well completion to help optimize production by equalizing reservoir inflow along the length of the wellbore.

The industry would welcome methods to address one or more of the foregoing limitations.

### SUMMARY

Embodiments describe methods of treating a subterranean formation penetrated by a well bore are disclosed. The methods provide treatment fluids including degradable material.

In embodiments, disclosed are methods to treat formation damage or other service induced damage in a near wellbore region of a wellbore, comprising: placing a first amount of a first acid precursor material in the near wellbore region to form a diverting barrier and selectively reduce hydraulic conductivity between the first zone and the wellbore, the first acid precursor having a first average particle size of about 1000 microns or less (or 2-100 microns or 3-50 microns or 5-20 microns); pumping a first amount of a treatment fluid into the wellbore; diverting the first amount of the treatment fluid from the first zone to a zone other than the first zone of the near wellbore region; at least partially removing damage from the zone other than the first zone of the near wellbore region or damage to the formation adjacent to the near wellbore region of the zone other than the first zone, or both; and at least partially restoring the hydraulic conductivity between the first zone and the wellbore through at least the partial removal of the diverting barrier.

In some embodiments of these methods, fibers are placed in the wellbore with the first acid precursor material, the fibers having a length of from about 20 nm to about 10 mm and a diameter of from about 5 nm to about 100 μm; or the fibers can have a length from about 1 mm to about 10 mm or from about 1 mm to about 6 mm or from about 1 mm to about 3 mm and a diameter from about 1 μm to about 100 μm or from about 1 μm to about 50 μm or from about 1 μm to about 25 μm; or the fibers can have a length from about 20 nm to about 1 mm or from about 50 nm to about 1 mm or from about 100 nm to about 1 mm and a diameter from about 5 nm to about 1 μm or from about 5 nm to about 500 nm or from about 5 nm to about 50 nm. In some embodiments, the fibers are placed in the wellbore in a fluid at a concentration of from about 0.12 to 18 g/m³ (about 1 to 150 ppt). In some embodiments, the fibers comprise a second acid precursor material.

In further embodiments, disclosed are methods to treat formation damage or other service induced damage in a near wellbore region of a wellbore, comprising: providing a first treatment fluid; pumping a plurality of stages of the first treatment fluid into the wellbore for contact with a plurality of respective zones of the near wellbore region to at least partially remove formation damage from the respective zone of the near wellbore region or damage to the formation adjacent to the near wellbore, or both; providing a second treatment fluid comprising a carrier fluid, an acid precursor material having a first average particle size of about 1000 microns or less, (or 2-100 microns or 3-50 microns or 5-20 microns), and possibly fibers; alternately pumping in the wellbore respective stages of the second treatment fluid between sequentially preceding and subsequent ones of the stages of the first treatment fluid to form diverting barriers to reduce hydraulic conductivity between respective preceding and subsequent ones of the zones and the wellbore; diverting the subsequent ones of the first treatment fluid stages from a respective preceding zone of the near wellbore region to a respective subsequent zone of the near wellbore region; after a final stage of the second treatment fluid, pumping a final stage of the first treatment fluid into the wellbore and diverting the final stage of the first treatment fluid to a final one of the zones of the near wellbore region to at least partially remove formation damage from the final zone of the near wellbore region; and at least partially restoring the hydraulic conductivity between at least one of the plurality of zones and the wellbore through at least the partial removal of at least one of the diverting barriers.

In some embodiments of these methods, the second treatment fluid further comprises fibers having a length from about 20 nm to about 10 mm and a diameter of from about 5 nm to about 100 μm; or the fibers can have a length from about 1 mm to about 10 mm or from about 1 mm to about 6 mm or from about 1 mm to about 3 mm and a diameter from about 1 μm to about 100 μm or from about 1 μm to about 50 μm or from about 1 μm to about 25 μm; or the fibers can have a length from about 20 nm to about 1 mm or from about 50 nm to about 1 mm or from about 100 nm to about 1 mm and a diameter from about 5 nm to about 1 μm or from about 5 nm to about 500 nm or from about 5 nm to about 50 nm. In some embodiments, the fibers are present in the second treatment fluid at a concentration of from about 0.12 to 18 g/m³ (about 1 to 150 ppt). In some embodiments, the fibers comprise a second acid precursor material.

### BRIEF DESCRIPTION OF THE DRAWINGS

FIG. 1 schematically shows a mixture of acid precursor particulates and optionally fibers delivered through coiled tubing to a high permeability zone in the near wellbore region which is the least damaged of the zones (and which may be undamaged) or has been at least partially treated for near wellbore damage according to some embodiments of the present disclosure.

FIG. 2 schematically shows a mixture of acid precursor particulates and optionally fibers delivered through coiled tubing to a high permeability zone in the formation adjacent to the near wellbore region which is the least damaged of the zones (and which may be undamaged) or has been at least partially treated for near wellbore damage according to some embodiments of the present disclosure.

FIG. 3 schematically shows a mixture of acid precursor particulates and optionally fibers delivered to a high permeability zone occupying the near wellbore region and the formation adjacent to the near wellbore region which is the least damaged of the zones (and which may be undamaged) or has been at least partially treated for near wellbore damage according to some embodiments of the present disclosure.

FIG. 4 schematically shows acid precursor particulates delivered through coiled tubing and fibers optionally delivered through wellbore annulus to a high permeability zone in perforations in the formation adjacent to the near wellbore which is the least damaged of the zones (and which may be undamaged) or has been at least partially treated for near wellbore damage according to some embodiments of the present disclosure.

FIG. 5A schematically shows treatment of a high permeability zone in the formation adjacent to the near wellbore region which is the least damaged of the zones (and which may be undamaged) or has been at least partially treated for near wellbore damage according to some embodiments of the present disclosure.

FIG. 5B schematically shows delivery of a diversion stage to the treated high permeability zone in the formation adjacent to the near wellbore region of FIG. 5A according to some embodiments of the present disclosure.

FIG. 5C schematically shows treatment of the low permeability zone(s) in the formation adjacent to the near wellbore region of FIGS. 5A and 5B according to some embodiments of the present disclosure.

FIG. 6 schematically shows production from the treated zones of FIG. 5C after degradation of the diverter plug according to some embodiments of the present disclosure.

FIG. 7 is a plan view of a coiled tubing with a fiber optic tether, according to some embodiments of the present disclosure.

FIG. 8 is a vertical sectional view of the coiled tubing and fiber optic tether shown in FIG. 7.

FIG. 9 is a block flow diagram for treatment methods according to some embodiments of the present disclosure.

FIG. 10 is a plot of the particle size distribution of the acid precursor particles of Example 1 below according to some embodiments of the disclosure.

FIG. 11 is a graph comparing the permeability of some examples of fibers and acid precursor particulates used in Example 2 below according to some embodiments of the present disclosure.

FIG. 12 is a graph comparing the fluid loss (Berea sandstone) of some comparative and exemplary fibers and acid precursor particulates used in Example 3 below according to some embodiments of the present disclosure.

FIG. 13 is a graph of the fluid loss (Indiana limestone) of exemplary acid precursor particulates used in Example 4 below according to some embodiments of the present disclosure.

### DETAILED DESCRIPTION

At the outset, it should be noted that in the development of any actual embodiments, numerous implementation-specific decisions must be made to achieve the developer's specific goals, such as compliance with system and business related constraints, which can vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating some embodiments and should not be construed as a limitation to the scope and applicability. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and the inventor to be in possession of the entire range and all points within the range disclosed and to have enabled the entire range and all points within the range.

The following definitions are provided in order to aid those skilled in the art in understanding the detailed description.

The term “treatment”, or “treating”, refers to any subterranean operation that uses a fluid in conjunction with a desired function and/or for a desired purpose, such as treatment of near wellbore damage or damage to the formation adjacent to the near wellbore, including in damaged perforations in such formation. The term “treatment”, or “treating”, does not imply any particular action by the fluid.

As used herein, “ppt” means pounds per thousand U.S. gallons of treatment fluid, and the conversion is 1 ppt=0.12 g/m³.

The term “particulate” or “particle” refers to a solid 3D object with maximal dimension significantly less than 1 meter. Here “dimension” of the object refers to the distance between two arbitrary parallel planes, each plane touching the surface of the object at least one point. The maximal dimension refers to the biggest distance existing for the object between any two parallel planes and the minimal dimension refers to the smallest distance existing for the object between any two parallel planes. In some embodiments, the particulates used are with a ratio between the maximal and the minimal dimensions (particle aspect ratio x/y) of less than 5 or even of less than 3.

The term “fiber” refers to a solid 3D object having a thickness substantially smaller than its other dimensions, for example its length and width. Fiber aspect ratios (diameter/thickness, width/thickness, etc.) may be greater than or equal to about 6 and in some embodiments greater than or equal to about 10.

The term “coiled tubing” refers to a long, continuous length of pipe wound on a spool. The pipe is straightened prior to pushing into a wellbore and rewound to coil the pipe back onto the transport and storage spool. Depending on the pipe diameter, e.g., 2.5 cm to 11.4 cm (1 in. to 4½ in.), and the spool size, coiled tubing can range from 610 m to 4,570 m (2,000 ft to 15,000 ft) or greater length.

The term “permeability” refers to the ability or measurement of a porous medium to transmit fluids, and may be reported in darcies or millidarcies.

For the purposes of the disclosure, particles may be non-homogeneous which shall be understood in the context of the present disclosure as made of at least a continuous phase of degradable material containing a discontinuous phase of a discontinuous material such as a stabilizer or a hydrolysis accelerator. Non-homogeneous in the present disclosure also encompasses composite materials also sometimes referred to as compounded material. The non-homogeneous particles may be supplemented in the fluid with further homogeneous structure.

The terms “particle size”, “particulate size” and similar terms refer to the diameter (D) of the smallest imaginary circumscribed sphere that includes such particulate particle.

The term “average size” refers to an average size of solids in a group of solids of each type. In each group j of particles average size can be calculated as mass-weighted value

$${\overline{L}}_{j} = \frac{{\sum }_{i = 1}^{N} {l}_{i} {m}_{i}}{{\sum }_{i = 1}^{N} {m}_{i}}$$

Where N—the number of particles in the group, lᵢ, (i=1 . . . N)—sizes of individual particles or flakes; mᵢ (i=1 . . . N)—masses of individual particles or flakes.

While the embodiments described herewith refer to near wellbore damage treatment it is equally applicable to any well operations where zonal isolation is required such as well treatment operations, drilling operations, workover operations, etc.

The following disclosure is generally in the context of embodiments using a combination of a particulate acid precursor material and fibers.

In one aspect, the disclosure relates to a method to treat formation damage or other service induced damage in a near wellbore region of a wellbore, comprising: placing a first amount of a first acid precursor material in the near wellbore region or in the formation adjacent to the near wellbore region, or both, to form a diverting barrier and selectively reduce hydraulic conductivity between the first zone and the wellbore, the first acid precursor can have a first average particle size of about 1000 microns or less (or 2-100 or 3-50 or 5-20 microns); pumping a first amount of a treatment fluid into the wellbore; diverting the first amount of the treatment fluid from the first zone to a zone other than the first zone of the near wellbore region; at least partially removing damage from the zone other than the first zone of the near wellbore region or damage to the formation adjacent to the near wellbore region of the zone other than the first zone, or both; and at least partially restoring the hydraulic conductivity between the first zone and the wellbore through at least the partial removal of the diverting barrier. In some embodiments, prior to placing the first amount of the first acid precursor material in the near wellbore region: pumping a second amount of the treatment fluid into the wellbore; and at least partially removing damage from the first zone of the near wellbore region or damage to the formation adjacent to the near wellbore region of the first zone, or both.

In accordance with some embodiments, fibers are also placed in the near wellbore region to join the first amount of the first acid precursor material to form the diverting barrier. In such case, the fibers can have a length from about 20 nm to about 10 mm and a diameter of from about 5 nm to about 100 μm; or the fibers can have a length from about 1 mm to about 10 mm or from about 1 mm to about 6 mm or from about 1 mm to about 3 mm and a diameter from about 1 μm to about 100 μm or from about 1 μm to about 50 μm or from about 1 μm to about 25 μm; or the fibers can have a length from about 20 nm to about 1 mm or from about 50 nm to about 1 mm or from about 100 nm to about 1 mm and a diameter from about 5 nm to about 1 μm or from about 5 nm to about 500 nm or from about 5 nm to about 50 nm, and

In some embodiments, the placement of the fibers and the acid precursor material comprises pumping in the wellbore a slurry comprising a fluid carrier, one or a combination of: the fibers, the first acid precursor material, and a component selected from the group consisting of: (1) a viscoelastic surfactant system, (2) a viscosifying agent (3) an acid, (4) or combinations thereof.

In some embodiments, the placement of the acid precursor material, and optionally the fibers, comprises deploying a coiled tubing assembly in the well and wherein a slurry of one or a combination of the fibers and the first acid precursor material is pumped through a flow path defined by the coiled tubing. In embodiments, the fibers, as described above, are present in the slurry at a concentration of from about 0.12 to 18 g/m³ (about 1 to 150 ppt). In embodiments, a coiled tubing assembly comprises the coiled tubing as described herein and a fiber optic tether disposed in the flow path of the coiled tubing, and the method can further comprise taking distributed measurements from the fiber optic tether during one or more of: i) the pumping of the first amount of the treatment fluid, ii) the pumping of the second amount of the treatment fluid, iii) the pumping of the slurry, iv) the diversion of the second amount of the first treatment fluid, and v) the at least partial restoring of the hydraulic conductivity between the first zone and the wellbore through at least the partial removal of the diverting barrier, to observe the behavior of the treatment fluids or the diverting barrier placed in the near wellbore region. In embodiments, the coiled tubing assembly can further comprise a coiled tubing tool attached to the coiled tubing, and measurements can be taken from the coiled tubing tool during each of i)-v) set out above to observe the behavior of the treatment fluids or the diverting barrier placed in the subterranean formation.

In some embodiments, the placement of the acid precursor material, and optionally the fibers, comprises pumping a slurry comprising either the first acid precursor material or a mixture of the fibers and the first acid precursor material.

In some embodiments, the placement of the fibers and the acid precursor material comprises pumping a treatment stage comprising alternating slugs of a first slurry comprising the first acid precursor material (e.g., without or in the substantial absence of the fibers) alternated with a second slurry comprising the fibers (e.g., without or in the substantial absence of the first acid precursor material).

In some embodiments, the method further comprises pumping the first amount of the first acid precursor material through a screen, a gravel pack, a sleeve, an inflow control device (ICD) or the like, or a combination thereof. For example, the screen or gravel pack or sleeve or ICD may have openings larger than the first average particle size, e.g., 50% larger or 2 times as large or 2.5 times as large or 3 times as large, or otherwise sufficiently large to permit passage of the first acid precursor material.

In some embodiments, at least a first portion of the first amount of the first acid precursor material can be pumped first through the screen, gravel pack, sleeve, ICD or other mechanical device, followed by pumping the fibers alone or in combination with a second portion of the first amount of the fibers through the screen, gravel pack, sleeve, ICD or other mechanical device.

In some embodiments, the placement of the acid precursor material, and optionally the fibers, comprises deploying a coiled tubing assembly in the well and wherein a first slurry of the first acid precursor material is pumped through a flow path defined by the coiled tubing, and pumping a second slurry of the fibers in an annulus between the wellbore and the coiled tubing.

In some embodiments, the fibers and the acid precursor material are placed in the wellbore simultaneously with the first amount of the treatment fluid.

In some embodiments, the method further comprises pumping the first amount of the first acid precursor material to the near wellbore region in a perforation, or an open hole or a cased hole or through a slotted liner or through a screen, or through a gravel pack, or through a sleeve, or through an ICD or through any other mechanical device, and combinations thereof.

In some embodiments, the treatment fluid comprises any fluid useful for cleaning or treating or removing, or any combination thereof, near wellbore damage or damage to a formation adjacent to the near wellbore, or combinations thereof. Such treatment fluids include fluids for drilling mud removal, altering the rock wettability, removal of insoluble materials and clays, breaking of emulsions, and combinations thereof. The treatment fluid can include components selected from the group consisting of solvents, cleaning surfactants, non-ionic surfactants (including water-wetting surfactants), emulsifying surfactants (used when forming the treatment fluid into a microemulsion), water, brine, an acid, anionic surfactants, and combinations thereof. The treatment fluid can be in the form of a microemulsion or a single phase fluid. The solvents can be glycol ethers, the cleaning surfactants can be an alkyl sulfate, the non-ionic surfactants can be an alcohol alkoxylate and/or an alkyl polyglycoside, or combinations thereof, the emulsifying surfactants can be a polysorbate, the acid can be HCl, organic acids such as, but not limited to acetic acid, HF, and combinations thereof, the anionic surfactants can be an alkylbenzene sulfonate and/or an alkylsulphosuccinate, and combinations thereof.

In some embodiments, the method further comprises deploying a coiled tubing assembly in the well and wherein the first amount of the first acid precursor material is pumped through a flow path defined by the coiled tubing. For example, the placement of the fibers and the first acid precursor can comprise pumping both of the first acid precursor material and the fibers, either together as a mixture or separately as alternating slugs, or pumping a slurry of the first acid precursor material through a coiled tubing, and pumping a slurry of the fibers in an annulus between the wellbore and the coiled tubing.

In these or any other embodiments, the fibers have a length less than 3 mm and an aspect ratio of at least 10, and/or the first acid precursor material has an average size in the range of 5 to 20 microns, including in any of the foregoing embodiments wherein the first acid precursor material and/or the fibers are pumped through and/or to a screen, gravel pack, perforation, sleeve, ICD, coiled tubing, or other mechanical device. In some embodiments, the fibers are present in the second treatment fluid at a concentration of from about 0.12 to 18 g/m³ (about 1 to 150 ppt).

In some embodiments, the first acid precursor material has a multimodal particle size distribution. The first acid precursor material can have 2-5 or at least 2 or at least 3 or at least 4 or up to 5 particle size ranges. For a multimodal system, at least one size can be from 1-50 or from 1-40 or from 1-20 microns, and at least one size can be from 50-1000 or 50-100 or 100-200 or 200-1000 microns, or any combination thereof. For example, the first acid precursor can have a first particle size distribution between 5 and 20 microns, e.g., 5-10 microns, and a second particle size distribution between about 1.6 and 20 times larger than the first particle size distribution. Further, the first acid precursor material, may comprise 3, 4, 5 or more modes, e.g., where each successively larger mode is between about 1.6 and 20 times larger than the next smaller mode.

In some embodiments, the fibers comprise or consist essentially of a second acid precursor material, or a non-degradable material.

In some embodiments, the first and second (if present) acid precursor materials are selected from the group consisting of polylactic acid, polyglycolic acid, copolymers of lactic and glycolic acids, and the like, and combinations thereof.

In some embodiments, the method further comprises pumping respective spacer stages between stages of the treatment fluid and stages for the placement of the fibers and the first acid precursor material.

In another aspect, the present disclosure provides methods to treat formation damage or other service induced damage in a near wellbore region of a wellbore or damage to the formation adjacent to the near wellbore, or both, comprising: providing a first treatment fluid; pumping a plurality of stages of the first treatment fluid into the wellbore for contact with a plurality of respective zones of the near wellbore region to at least partially remove damage from the respective zone of the near wellbore region or damage to the formation adjacent to the near wellbore for such respective zone, or both; providing a second treatment fluid comprising a carrier fluid, an acid precursor material, and optionally fibers, each as described herein; the fibers can have a length from about 20 nm to about 10 mm and a diameter of from about 5 nm to about 100 μm; or the fibers can have a length from about 1 mm to about 10 mm or from about 1 mm to about 6 mm or from about 1 mm to about 3 mm and a diameter from about 1 μm to about 100 μm or from about 1 μm to about 50 μm or from about 1 μm to about 25 μm; or the fibers can have a length from about 20 nm to about 1 mm or from about 50 nm to about 1 mm or from about 100 nm to about 1 mm and a diameter from about 5 nm to about 1 μm or from about 5 nm to about 500 nm or from about 5 nm to about 50 nm, and the first acid precursor can have a first average particle size of about 1000 microns or less (or 2-100 or 3-50 or 5-20 microns); alternately pumping in the wellbore respective stages of the second treatment fluid between sequentially preceding and subsequent ones of the stages of the first treatment fluid to form diverting barriers to reduce hydraulic conductivity between respective preceding and subsequent ones of the zones and the wellbore; diverting the subsequent ones of the first treatment fluid stages from a respective preceding zone of the near wellbore region to a respective subsequent zone of the near wellbore region; after a final stage of the second treatment fluid, pumping a final stage of the first treatment fluid into the wellbore and diverting the final stage of the first treatment fluid to a final one of the zones of the near wellbore region to at least partially remove formation damage from the final zone of the near wellbore region; and at least partially restoring the hydraulic conductivity between at least one of the plurality of zones and the wellbore through at least the partial removal of at least one of the diverting barriers.

In some embodiments, the method comprises deploying a coiled tubing assembly in the well and wherein at least the second treatment fluid stages are pumped through a flow path defined by the coiled tubing. In embodiments, a coiled tubing assembly comprises the coiled tubing as described herein and a fiber optic tether disposed in the flow path of the coiled tubing, and the method can further comprise taking distributed measurements from a fiber optic tether during one or more of: i) pumping a plurality of stages of the first treatment fluid ii) the pumping of the respective stages of the second treatment fluid, iii) the diverting of the subsequent ones of the first treatment fluid stages, and iv) the at least partial restoring of the hydraulic conductivity between at least one of the plurality of zones and the wellbore through at least the partial removal of at least one of the diverting barriers, to observe the behavior of the first and second treatment fluids or the diverting barrier placed in the near wellbore region. In embodiments, the coiled tubing assembly can further comprise a coiled tubing tool attached to the coiled tubing, and measurements can be taken from the coiled tubing tool during each of i)-iv) set out above to observe the behavior of the treatment fluids or the diverting barrier placed in the subterranean formation.

In some embodiments, the method comprises pumping the second treatment fluid through a screen, a gravel pack, a perforation, a sleeve, an ICD, coiled tubing, or other mechanical device, or a combination thereof.

In some embodiments, the first treatment fluid comprises the treatment fluid as described herein.

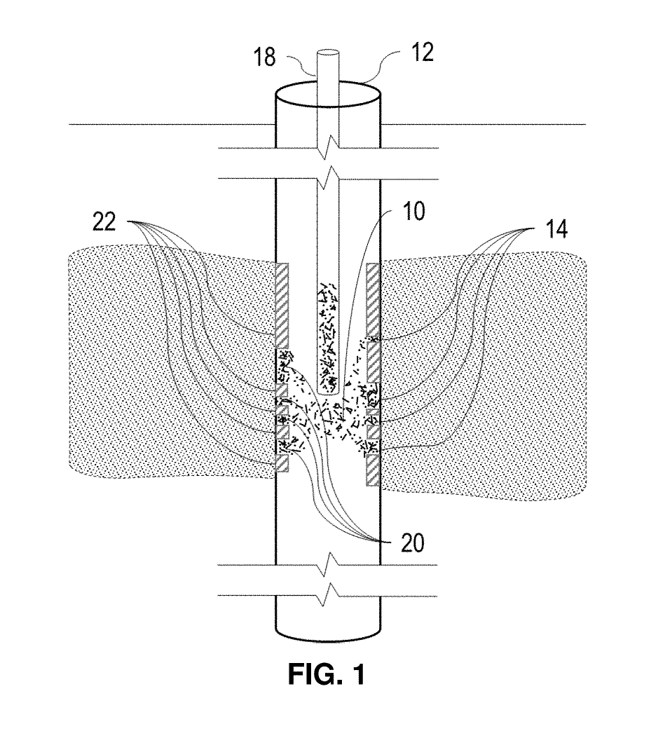

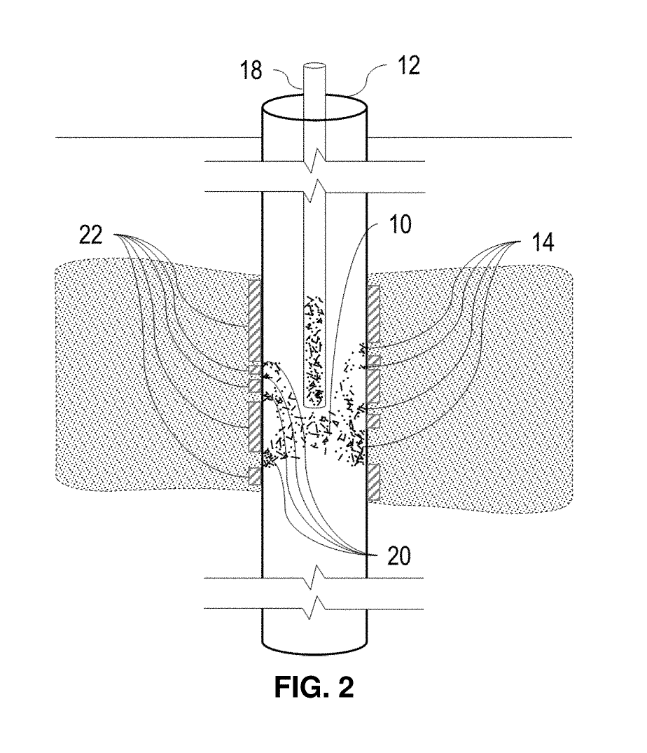

With reference to the drawings, in which like elements are indicated by like numbers, FIG. 1 schematically shows the mixture 10 of acid precursor particulates and the optional fibers delivered in a wellbore 12 to high permeability zones 14 delivered through coiled tubing 18. For FIG. 1, and FIGS. 2-5C, the mixture 10 can comprise the acid precursor particulates alone or the acid precursor particulates mixed with the optional fibers. The plugs 20 divert treatment fluid from zones 14 to lower permeability zones 22. FIG. 1 shows the damage being treated as in the near wellbore region, but, as shown in subsequent Figures, the damage to be treated can also be in the formation adjacent to the near wellbore region, or in both.

FIG. 2 shows the mixture 10 of acid precursor particulates and the optional fibers delivered in a wellbore 12 to high permeability zones 14 delivered through coiled tubing 18 as in FIG. 1, except that the damage to be treated 22 is shown to be in the formation adjacent to the near wellbore region.

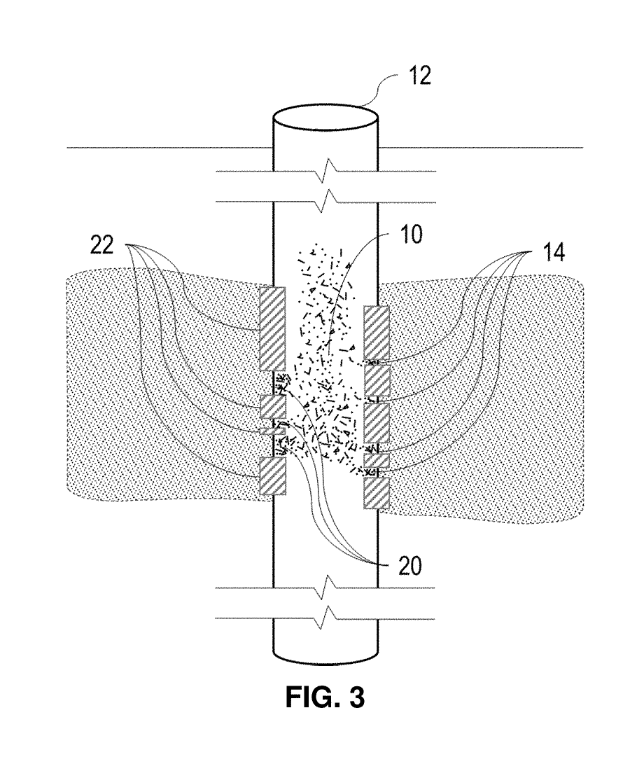

FIG. 3 schematically shows a mixture 10 of acid precursor particulates and the optional fibers delivered in a wellbore 12 to a high permeability zone 14 in the near wellbore region, which may have been previously treated with a treatment fluid as shown in FIG. 1, except that the mixture is delivered to high permeability zones 14 through the wellbore and not through coiled tubing, and the damage to be treated is shown to be both in the near wellbore region and in the formation adjacent to the near wellbore region. The carrier fluid from the mixture 10 enters the high permeability zone 14, depositing a particle (and optionally fiber-containing) filter cake that form plugs 20 in high permeability zones 14 to reduce permeability and hydraulic conductivity between the zone 14 and the wellbore 12. The next treatment fluid stage is then diverted from zones 14 to lower permeability zones 22, i.e., the next highest permeability zones.

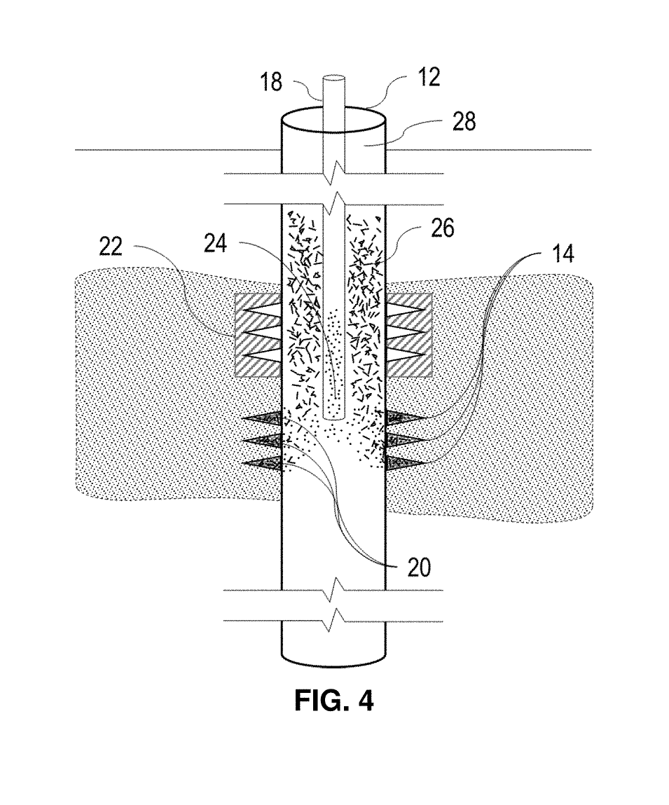

FIG. 4 schematically shows acid precursor particulates 24 delivered through coiled tubing 18 and the optional fibers 26 delivered through the annulus 28 between the coiled tubing 18 and the wellbore 12 to the high permeability zones 14 to form plugs 20 and divert treatment fluid to lower permeability zones 22.

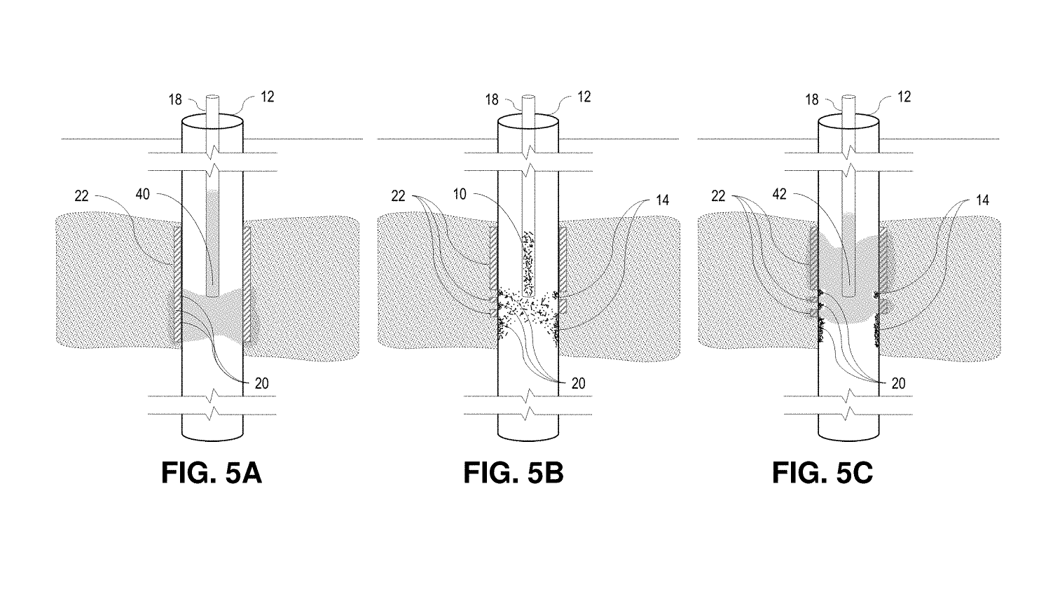

FIG. 5A schematically shows treatment of formation damage 22 with a treatment fluid 40. The treatment fluid 40 can be delivered through the coiled tubing 18.

FIG. 5B schematically shows placement of a diversion stage of a mixture 10 of the particulates and showing the optional fibers to the treated high permeability zones 14 of FIG. 5A, as in FIG. 1 above.

FIG. 5C next shows treatment of the low permeability zones 22 with a treatment fluid 42 being diverted from zones 14 at the plugs 20.

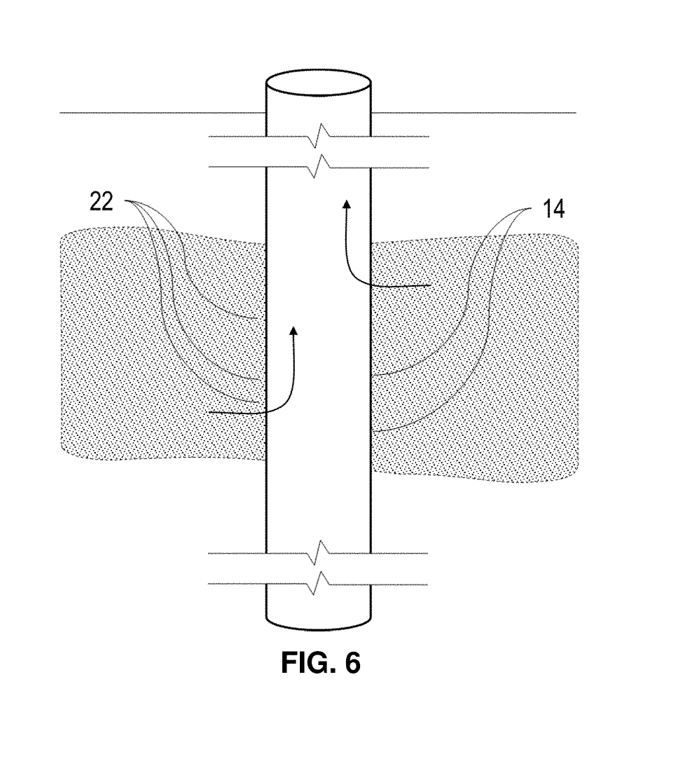

FIG. 6 shows production from the treated zones 14, 22 of FIG. 5C after degradation of the diverter plugs 20 (FIGS. 5B and 5C).

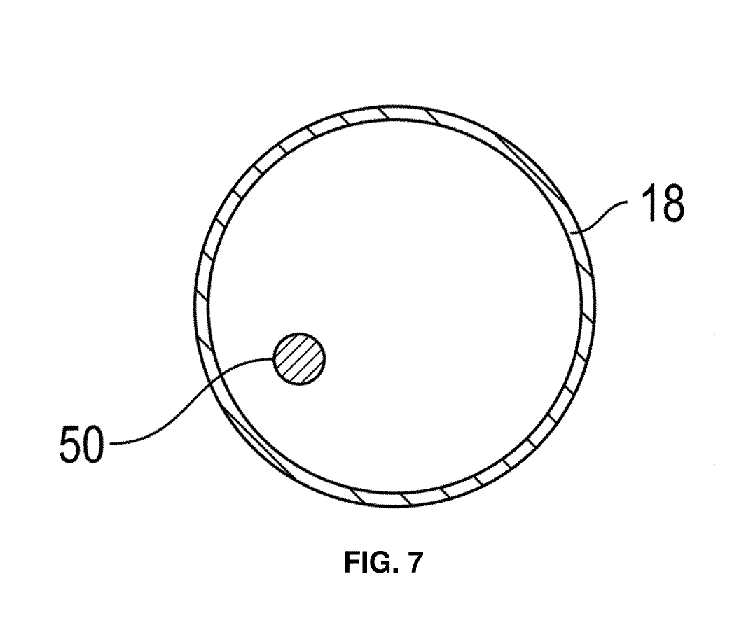

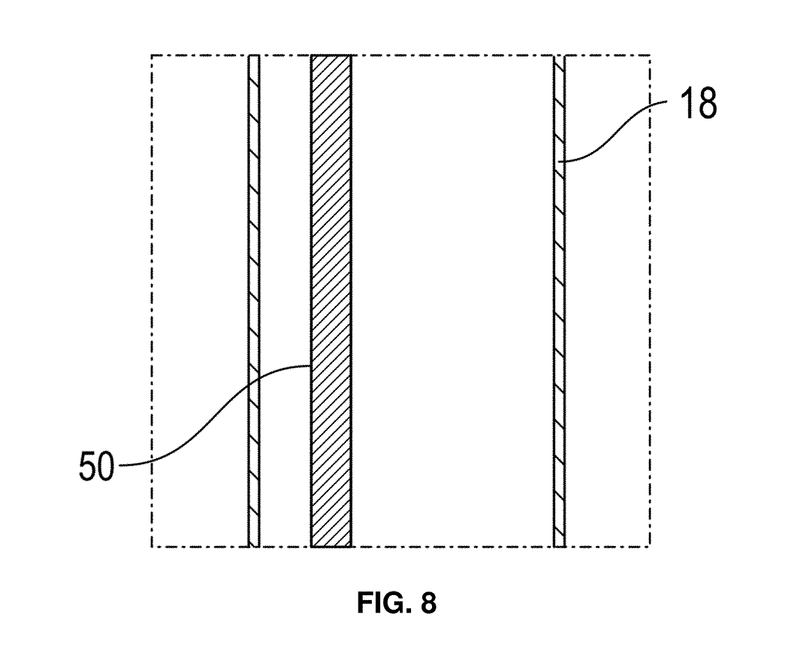

FIGS. 7 and 8 show a coiled tubing 18 with a fiber optic tether 50, which may be present in any embodiments described herein, regardless of whether the coiled tubing 18 is present. Fiber optic tether 50 uses optical time-domain reflectometry to obtain temperature, pressure, vibration, and the like, readings along the length of the fiber optic tether. Other properties that can be determined with fiber optic tethers include pressure, fluid flow, acidity, viscosity, resistivity, composition, etc. The fiber optic tether can be placed in the coiled tubing 30 in the central passageway thereof, or attached or embedded in a wall of the tubing. Temperature, pressure or vibration changes can be used to indicate fluid flow locations in real time, and thus zones of the well that are receiving the treatment fluid. More information regarding distributed sensors, such as fiber optic tethers, and their configuration and use in wellbores and/or coiled tubing is available in US2004/0129418; US2014/0102695; US2014/0130591; US2014/0150546; US2014/0151032; US2014/0157884; US2014/0165715; US2014/0231074; US2011/0315375; US2005/0263281; all of which are hereby incorporated herein by reference in their entireties.

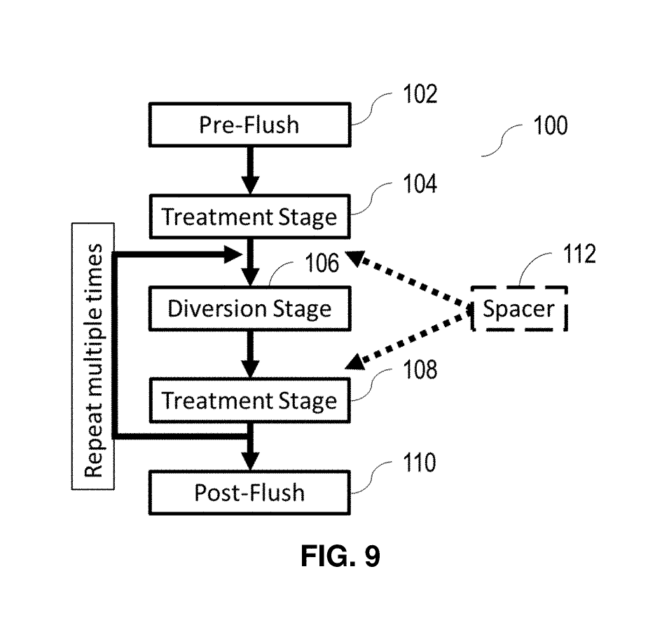

FIG. 9 is a block flow diagram 100 for treatment methods and/or systems shown according to any of FIGS. 1 to 8. In an initial step 102, a pre-flush stage is pumped into the wellbore. Next, in step 104, a treatment fluid stage is pumped to the highest permeability zone. After pumping the diversion stage in step 106, another fluid treatment stage is pumped in step 108 to the next highest permeability zone. Steps 106 and 108 are then optionally repeated one or more times until all the zones desired to be treated have been treated and a final post-flush stage is pumped in step 110. If desired, a spacer can be pumped in step 112 to separate the treatment fluid stages from the diversion stages. Also, in accordance with an embodiment, the diversion stage 106 can be pumped simultaneously with, and in some cases as a part of, the treatment fluid stage 104.

### Diverter Fluid

The treatment fluids containing the particulates and optionally the fibers in this disclosure for near wellbore diversion are sometimes referred to herein as the “diverter fluid”, the “second treatment fluid”, or the like. This fluid contains the fibers, the acid precursor particles, or both. The modifier “second” does not necessarily indicate any particular importance, order, or relative characteristic, and is used herein solely to distinguish diverter fluids from the main or first treatment fluids described herein.

The carrier fluid used in the second treatment fluid can be acidic, but is non-acidic in most embodiments. The carrier fluid may be water: fresh water, produced water, seawater. Other non-limiting examples of carrier fluids include hydratable gels (e.g. guars, poly-saccharides, xanthan, hydroxy-ethyl-cellulose, etc.), a cross-linked hydratable gel, an energized fluid (e.g. an N2 or CO2 based foam), a viscoelastic surfactant fluid, and an oil-based fluid including a gelled, foamed, or otherwise viscosified oil. Additionally, the carrier fluid may be a brine, and/or may include a brine.

### Acid Precursor Materials

The acid precursor particulates are embodied as having an average particle size as small as 1 micron or less, and as large as 1000 microns. In some embodiments, the acid precursor material is less than 200 microns, or less than 100 microns, e.g., 2-100 microns or 3-50 microns or 5-20 microns or 5-10 microns. The smaller sizes mentioned, e.g., 2-50 microns or 3-20 microns or 5-20 microns or 5-10 microns, can pass through a coiled tubing string with complex flow paths, very small exit ports, screens, etc. These smaller sizes are also capable of passing through the screens, gravel packs, or other mechanical sand control devices.

In some embodiments, the acid precursor material is unimodal and or may have a small particle size, e.g., 2-50 microns or 3-20 microns or 5-20 microns or 5-10 microns. In some embodiments, the acid precursor material is multimodal, as otherwise described herein.

The acid precursor material is used in the diverter fluid at a concentration sufficient to build a diverting barrier at the diversion location, based on the amount of fluid to be used in the diverter. The acid precursor loading in the diverter fluid may range from about 1 to about 3000 ppt, or from about 1 to about 1500 ppt, or from about 1 to about 750 ppt.

Non-limiting examples of degradable materials that may be used in both treatment fluids include certain polymer materials that are capable of generating acids upon degradation. These polymer materials may herein be referred to as “polymeric acid precursors.” These materials are typically solids at room temperature. The polymeric acid precursor materials include the polymers and oligomers that hydrolyze or degrade in certain chemical environments under known and controllable conditions of temperature, time and pH to release organic acid molecules that may be referred to as “monomeric organic acids.” As used herein, the expression “monomeric organic acid” or “monomeric acid” may also include dimeric acid or acid with a small number of linked monomer units that function similarly to monomer acids composed of only one monomer unit.

Polymer materials may include those polyesters obtained by polymerization of hydroxycarboxylic acids, such as the aliphatic polyester of lactic acid, referred to as polylactic acid; glycolic acid, referred to as polyglycolic acid; 3-hydroxbutyric acid, referred to as polyhydroxybutyrate; 2-hydroxyvaleric acid, referred to as polyhydroxyvalerate; epsilon caprolactone, referred to as polyepsilon caprolactone or polyprolactone; the polyesters obtained by esterification of hydroxyl aminoacids such as serine, threonine and tyrosine; and the copolymers obtained by mixtures of the monomers listed above. A general structure for the above-described homopolyesters is:

H—{O—[C(R1,R2)]x-[C(R3,R4)]y-C═O}z-OH

where,
R1, R2, R3, R4 is either H, linear alkyl, such as CH3, CH2CH3 (CH2)nCH3, branched alkyl, aryl, alkylaryl, a functional alkyl group (bearing carboxylic acid groups, amino groups, hydroxyl groups, thiol groups, or others) or a functional aryl group (bearing carboxylic acid groups, amino groups, hydroxyl groups, thiol groups, or others);
x is an integer between 1 and 11;
y is an integer between 0 and 10; and
z is an integer between 2 and 50,000.

In the appropriate conditions (pH, temperature, water content) polyesters like those described herein can hydrolyze and degrade to yield hydroxycarboxylic acid and compounds that pertain to those acids referred to in the foregoing as “monomeric acids.”

One example of a suitable polymeric acid precursor, as mentioned above, is the polymer of lactic acid, sometimes called polylactic acid, “PLA”, polylactate or polylactide. Lactic acid is a chiral molecule and has two optical isomers. These are D-lactic acid and L-lactic acid. The poly(L-lactic acid) and poly(D-lactic acid) forms are generally crystalline in nature. Polymerization of a mixture of the L- and D-lactic acids to poly(DL-lactic acid) results in a polymer that is more amorphous in nature. The polymers described herein are essentially linear. The degree of polymerization of the linear polylactic acid can vary from a few units (2-10 units) (oligomers) to several thousands (e.g. 2000-5000). Cyclic structures may also be used. The degree of polymerization of these cyclic structures may be smaller than that of the linear polymers. These cyclic structures may include cyclic dimers.

Another example is the polymer of glycolic acid (hydroxyacetic acid), also known as polyglycolic acid (“PGA”), or polyglycolide. Other materials suitable as polymeric acid precursors are all those polymers of glycolic acid with itself or other hydroxy-acid-containing moieties, as described in U.S. Pat. Nos. 4,848,467; 4,957,165; and 4,986,355, which are herein incorporated by reference.

The polylactic acid and polyglycolic acid may each be used as homopolymers, which may contain less than about 0.1% by weight of other comonomers. As used with reference to polylactic acid, “homopolymer(s)” is meant to include polymers of D-lactic acid, L-lactic acid and/or mixtures or copolymers of pure D-lactic acid and pure L-lactic acid. Additionally, random copolymers of lactic acid and glycolic acid and block copolymers of polylactic acid and polyglycolic acid may be used. Combinations of the described homopolymers and/or the above-described copolymers may also be used.

Other examples of polyesters of hydroxycarboxylic acids that may be used as polymeric acid precursors are the polymers of hydroxyvaleric acid (polyhydroxyvalerate), hydroxybutyric acid (polyhydroxybutyrate) and their copolymers with other hydroxycarboxylic acids. Polyesters resulting from the ring opening polymerization of lactones such as epsilon caprolactone (polyepsiloncaprolactone) or copolymers of hydroxyacids and lactones may also be used as polymeric acid precursors.

Polyesters obtained by esterification of other hydroxyl-containing acid-containing monomers such as hydroxyaminoacids may be used as polymeric acid precursors. Naturally occurring aminoacids are L-aminoacids. Among the 20 most common aminoacids the three that contain hydroxyl groups are L-serine, L-threonine, and L-tyrosine. These aminoacids may be polymerized to yield polyesters at the appropriate temperature and using appropriate catalysts by reaction of their alcohol and their carboxylic acid group. D-aminoacids are less common in nature, but their polymers and copolymers may also be used as polymeric acid precursors.

NatureWorks, LLC, Minnetonka, Minn., USA, produces solid cyclic lactic acid dimer called “lactide” and from it produces lactic acid polymers, or polylactates, with varying molecular weights and degrees of crystallinity, under the generic trade name NATUREWORKS™ PLA. The PLA's currently available from NatureWorks, LLC have number averaged molecular weights (Mn) of up to about 100,000 and weight averaged molecular weights (Mw) of up to about 200,000, although any polylactide (made by any process by any manufacturer) may be used. Those available from NatureWorks, LLC typically have crystalline melt temperatures of from about 120 to about 170° C., but others are obtainable. Poly(d,l-lactide) at various molecular weights is also commercially available from Bio-Invigor, Beijing and Taiwan. Bio-Invigor also supplies polyglycolic acid (also known as polyglycolide) and various copolymers of lactic acid and glycolic acid, often called “polyglactin” or poly(lactide-co-glycolide).

The extent of the crystallinity can be controlled by the manufacturing method for homopolymers and by the manufacturing method and the ratio and distribution of lactide and glycolide for the copolymers. Additionally, the chirality of the lactic acid used also affects the crystallinity of the polymer. Polyglycolide can be made in a porous form. Some of the polymers dissolve very slowly in water before they hydrolyze.

Amorphous polymers may be useful in certain applications. An example of a commercially available amorphous polymer is that available as NATUREWORKS 4060D PLA, available from NatureWorks, LLC, which is a poly(DL-lactic acid) and contains approximately 12% by weight of D-lactic acid and has a number average molecular weight (Mn) of approximately 98,000 g/mol and a weight average molecular weight (Mw) of approximately 186,000 g/mol.

Other polymer materials that may be useful are the polyesters obtained by polymerization of polycarboxylic acid derivatives, such as dicarboxylic acids derivatives with polyhydroxy containing compounds, in particular dihydroxy containing compounds. Polycarboxylic acid derivatives that may be used are those dicarboxylic acids such as oxalic acid, propanedioic acid, malonic acid, fumaric acid, maleic acid, succinic acid, glutaric acid, pentanedioic acid, adipic acid, phthalic acid, isophthalic acid, terphthalic acid, aspartic acid, or glutamic acid; polycarboxylic acid derivatives such as citric acid, poly and oligo acrylic acid and methacrylic acid copolymers; dicarboxylic acid anhydrides, such as, maleic anhydride, succinic anhydride, pentanedioic acid anhydride, adipic anhydride, phthalic anhydride; dicarboxylic acid halides, primarily dicarboxylic acid chlorides, such as propanedioic acyl chloride, malonyl chloride, fumaroyl chloride, maleyl chloride, succinyl chloride, glutaroyl chloride, adipoil chloride, phthaloyl chloride. Useful polyhydroxy containing compounds are those dihydroxy compounds such as ethylene glycol, propylene glycol, 1,4 butanediol, 1,5 pentanediol, 1,6 hexanediol, hydroquinone, resorcinol, bisphenols such as bisphenol acetone (bisphenol A) or bisphenol formaldehyde (bisphenol F); polyols such as glycerol. When both a dicarboxylic acid derivative and a dihydroxy compound are used, a linear polyester results. It is understood that when one type of dicaboxylic acid is used, and one type of dihydroxy compound is used, a linear homopolyester is obtained. When multiple types of polycarboxylic acids and/or polyhydroxy containing monomer are used copolyesters are obtained. According to the Flory Stockmayer kinetics, the “functionality” of the polycarboxylic acid monomers (number of acid groups per monomer molecule) and the “functionality” of the polyhydroxy containing monomers (number of hydroxyl groups per monomer molecule) and their respective concentrations, will determine the configuration of the polymer (linear, branched, star, slightly crosslinked or fully crosslinked). All these configurations can be hydrolyzed or “degraded” to carboxylic acid monomers, and therefore can be considered as polymeric acid precursors. As a particular case example, not willing to be comprehensive of all the possible polyester structures one can consider, but just to provide an indication of the general structure of the most simple case one can encounter, the general structure for the linear homopolyesters is:

H—{O—R1-O—C═O—R2-C═O}z-OH

where,
R1 and R2, are linear alkyl, branched alkyl, aryl, alkylaryl groups; and
z is an integer between 2 and 50,000.

Other examples of suitable polymeric acid precursors are the polyesters derived from phtalic acid derivatives such as polyethylenetherephthalate (PET), polybutylentetherephthalate (PBT), polyethylenenaphthalate (PEN), and the like.

In the appropriate conditions (pH, temperature, water content) polyesters like those described herein can “hydrolyze” and “degrade” to yield polycarboxylic acids and polyhydroxy compounds, irrespective of the original polyester being synthesized from either one of the polycarboxylic acid derivatives listed above. The polycarboxylic acid compounds the polymer degradation process will yield are also considered monomeric acids.

Other examples of polymer materials that may be used are those obtained by the polymerization of sulfonic acid derivatives with polyhydroxy compounds, such as polysulphones or phosphoric acid derivatives with polyhydroxy compounds, such as polyphosphates.

Such solid polymeric acid precursor material may be capable of undergoing an irreversible breakdown into fundamental acid products downhole. As referred to herein, the term “irreversible” will be understood to mean that the solid polymeric acid precursor material, once broken downhole, should not reconstitute while downhole, e.g., the material should break down in situ but should not reconstitute in situ. The term “break down” refers to both the two relatively extreme cases of hydrolytic degradation that the solid polymeric acid precursor material may undergo, e.g., bulk erosion and surface erosion, and any stage of degradation in between these two. This degradation can be a result of, inter alia, a chemical reaction. The rate at which the chemical reaction takes place may depend on, inter alia, the chemicals added, temperature and time. The breakdown of solid polymeric acid precursor materials may or may not depend, at least in part, on its structure. For instance, the presence of hydrolyzable and/or oxidizable linkages in the backbone often yields a material that will break down as described herein. The rates at which such polymers break down are dependent on factors such as, but not limited to, the type of repetitive unit, composition, sequence, length, molecular geometry, molecular weight, morphology (e.g., crystallinity, size of spherulites, and orientation), hydrophilicity, hydrophobicity, surface area, and additives. The manner in which the polymer breaks down also may be affected by the environment to which the polymer is exposed, e.g., temperature, presence of moisture, oxygen, microorganisms, enzymes, pH, and the like.

Some suitable examples of solid polymeric acid precursor material that may be used include, but are not limited to, those described in the publication of Advances in Polymer Science, Vol. 157 entitled “Degradable Aliphatic Polyesters,” edited by A. C. Albertsson, pages 1-138. Examples of polyesters that may be used include homopolymers, random, block, graft, and star- and hyper-branched aliphatic polyesters.

Another class of suitable solid polymeric acid precursor material that may be used includes polyamides and polyimides. Such polymers may comprise hydrolyzable groups in the polymer backbone that may hydrolyze under the conditions that exist in cement slurries and in a set cement matrix. Such polymers also may generate byproducts that may become sorbed into a cement matrix. Calcium salts are a non-limiting example of such byproducts. Non-limiting examples of suitable polyamides include proteins, polyaminoacids, nylon, and poly(caprolactam). Another class of polymers that may be suitable for use are those polymers that may contain hydrolyzable groups, not in the polymer backbone, but as pendant groups. Hydrolysis of the pendant groups may generate a water-soluble polymer and other byproducts that may become sorbed into the cement composition. A non-limiting example of such a polymer includes polyvinylacetate, which upon hydrolysis forms water-soluble polyvinylalcohol and acetate salts.

The degradable particulates may further comprise a stabilizer such as a carbodiimide or a hydrolysis accelerator such as a metal salt, in embodiments the accelerator may be a lightly burnt magnesium oxide. In some embodiments the acid precursor material may contain or be used in a treatment fluid with a pH control agent as disclosed in U.S. Pat. No. 7,219,731, which is hereby incorporated herein by reference.

The particle(s) can be embodied as material reacting with chemical agents. Some examples of materials that may be removed by reacting with other agents are carbonates including calcium and magnesium carbonates and mixtures thereof (reactive to acids and chelates); acid soluble cement (reactive to acids); polyesters including esters of lactic hydroxylcarbonic acids and copolymers thereof (can be hydrolyzed with acids and bases).

Fibers

As mentioned when fibers are present in the fluid, i.e. the diverter fluid contains fibers, said fibers are optional in the first treatment fluid; said fibers may be straight, curved, bent or undulated. Other non-limiting shapes may include hollow, generally spherical, rectangular, polygonal, etc. Fibers or elongated particles may be used in bundles. The fibers may have a length from about 20 nm to about 10 mm and a diameter of from about 5 nm to about 100 μm; or the fibers can have a length from about 1 mm to about 10 mm or from about 1 mm to about 6 mm or from about 1 mm to about 3 mm and a diameter from about 1 μm to about 100 μm or from about 1 μm to about 50 μm or from about 1 μm to about 25 μm; or the fibers can have a length from about 20 nm to about 1 mm or from about 50 nm to about 1 mm or from about 100 nm to about 1 mm and a diameter from about 5 nm to about 1 μm or from about 5 nm to about 500 nm or from about 5 nm to about 50 nm.

In embodiments, the fibers are used in the diverter fluid or delivery slurry, separately or together with the acid precursor particulates, at a concentration sufficient to build a barrier at the diversion location, depending on the relative size or volume of larger openings that must be plugged based on the amount of fluid to be used to place the fibers in the desired location. The fiber loading in the diverter fluid may range from about 0.12 g/L (about 1 ppt) to about 18 g/L (about 150 ppt), for example from about 0.12 g/m3 (about 1 ppt) to about 6 g/L (about 50 ppt). The proportion and physical dimensions of the fiber, and the particular fiber utilized, depend on a number of variables, including the characteristics of the diverter or treatment fluid, and the chemical and physical characteristics of the formation. For instance, longer fibers may be utilized in near wellbore regions or formations adjacent to the near wellbore region that are highly fractured and/or in which the naturally occurring fractures are quite large, and it may be advantageous to utilize higher concentrations of such fibers for use in such formations. On the other hand, smaller fibers and lower concentrations may be preferred when working with coiled tubing, screens, gravel packs, or other small flow passage situations.

The fiber may be formed from a degradable material or a non-degradable material. The fiber may be organic or inorganic. Non-degradable materials are those wherein the fiber remains substantially in its solid form within the well fluids. Examples of such materials include cellulose, glass, ceramics, basalt, carbon and carbon-based compound, metals and metal alloys, etc. Polymers and plastics that are non-degradable may also be used as non-degradable fibers. These may include high-density plastic materials that are acid and oil-resistant and exhibit a crystallinity of greater than 10%. Other non-limiting examples of polymeric materials include nylons, acrylics, styrenes, polyesters, polyethylene, oil-resistant thermoset resins and combinations of these.

Degradable fibers may include those materials that can be softened, dissolved, reacted or otherwise made to degrade within the well fluids. Such materials may be soluble in aqueous fluids or in hydrocarbon fluids. Oil-degradable particulate materials may be used that degrade in the produced fluids. Non-limiting examples of degradable materials may include, without limitation, polyvinyl alcohol, polyethylene terephthalate (PET), polyethylene, dissolvable salts, polysaccharides, waxes, benzoic acid, naphthalene based materials, magnesium oxide, sodium bicarbonate, calcium carbonate, sodium chloride, calcium chloride, ammonium sulfate, soluble resins, and the like, and combinations of these. Degradable materials may also include those that are formed from solid-acid precursor materials. These materials may include polylactic acid (PLA), polyglycolic acid (PGA), carboxylic acid, lactide, glycolide, copolymers of PLA or PGA, and the like, and combinations of these. Such materials may also further facilitate the dissolving of the formation in the acid fracturing treatment. When degradable fibers are being used, they may optionally also be a compounded material containing the stabilizer.

In embodiments, the fibers comprise a second acid precursor material, which may be the same or different with respect to the acid precursor particulates.

Also, fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) fibers available from Invista Corp., Wichita, Kans., USA, 67220. Other examples of useful fibers include, but are not limited to, polylactic acid polyester fibers, polyglycolic acid polyester fibers, polyvinyl alcohol fibers, and the like.

### Viscosifying Agents

In certain further embodiments, the second treatment fluid carrier fluid contains a viscosifying agent. The viscosifying agent may be any crosslinked polymers. The polymer viscosifier can be a metal-crosslinked polymer. Suitable polymers for making the metal-crosslinked polymer viscosifiers include, for example, polysaccharides such as substituted galactomannans, such as guar gums, high-molecular weight polysaccharides composed of mannose and galactose sugars, or guar derivatives such as hydroxypropyl guar (HPG), carboxymethylhydroxypropyl guar (CMHPG) and carboxymethyl guar (CMG), hydrophobically modified guars, guar-containing compounds, and synthetic polymers. Crosslinking agents based on boron, titanium, zirconium or aluminum complexes are typically used to increase the effective molecular weight of the polymer and make them better suited for use in high-temperature wells.

Other suitable classes of polymers effective as viscosifying agent include polyvinyl polymers, polymethacrylamides, cellulose ethers, lignosulfonates, and ammonium, alkali metal, and alkaline earth salts thereof. More specific examples of other typical water-soluble polymers are methacrylamide copolymers, polyacrylamides, partially hydrolyzed polyacrylamides, partially hydrolyzed polymethacrylamides, polyvinyl alcohol, polyalkyleneoxides, other galactomannans, heteropolysaccharides obtained by the fermentation of starch-derived sugar and ammonium and alkali metal salts thereof.

Cellulose derivatives are used to a smaller extent, such as hydroxyethylcellulose (HEC) or hydroxypropylcellulose (HPC), carboxymethylhydroxyethylcellulose (CMHEC) and carboxymethycellulose (CMC), with or without crosslinkers. Xanthan, diutan, and scleroglucan, three biopolymers, have been shown to have excellent particulate-suspension ability even though they are more expensive than guar derivatives and therefore have been used less frequently, unless they can be used at lower concentrations.

In other embodiments, the viscosifying agent is made from a crosslinkable, hydratable polymer and a delayed crosslinking agent, wherein the crosslinking agent comprises a complex comprising a metal and a ligand. Also the crosslinked polymer can be made from a polymer comprising pendant ionic moieties, a surfactant comprising oppositely charged moieties, a clay stabilizer, a borate source, and a metal crosslinker. Said embodiments are described in U.S. Patent Publications US2008-0280790 and US2008-0280788 respectively, each of which are incorporated herein by reference.

### Viscoelastic Surfactant Systems

The viscosifying agent may be a viscoelastic surfactant (VES). The VES may be selected from the group consisting of cationic, anionic, zwitterionic, amphoteric, nonionic and combinations thereof. Some non-limiting examples are those cited in U.S. Pat. No. 6,435,277 (Qu et al.) and U.S. Pat. No. 6,703,352 (Dahayanake et al.), each of which are incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

In general, particularly suitable zwitterionic surfactants have the formula:

RCONH—(CH2)a(CH2CH2O)m(CH2)b-N+(CH3)2-(CH2)a′(CH2CH2O)m′(CH2)b′COO—

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH2CH2O may also be OCH2CH2. In some embodiments, zwitterionic surfactants of the family of betaine is used.

Exemplary cationic viscoelastic surfactants include the amine salts and quaternary amine salts disclosed in U.S. Pat. Nos. 5,979,557, and 6,435,277 which are hereby incorporated by reference. Examples of suitable cationic viscoelastic surfactants include cationic surfactants having the structure:

R1N⁺(R2)(R3)(R4)X⁻

in which R1 has from about 14 to about 26 carbon atoms and may be branched or straight chained, aromatic, saturated or unsaturated, and may contain a carbonyl, an amide, a retroamide, an imide, a urea, or an amine; R2, R3, and R4 are each independently hydrogen or a C1 to about C6 aliphatic group which may be the same or different, branched or straight chained, saturated or unsaturated and one or more than one of which may be substituted with a group that renders the R2, R3, and R4 group more hydrophilic; the R2, R3 and R4 groups may be incorporated into a heterocyclic 5- or 6-member ring structure which includes the nitrogen atom; the R2, R3 and R4 groups may be the same or different; R1, R2, R3 and/or R4 may contain one or more ethylene oxide and/or propylene oxide units; and X— is an anion. Mixtures of such compounds are also suitable. As a further example, R1 is from about 18 to about 22 carbon atoms and may contain a carbonyl, an amide, or an amine, and R2, R3, and R4 are the same as one another and contain from 1 to about 3 carbon atoms.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R1CON(R2)CH2X

wherein R1 is a hydrophobic chain having about 12 to about 24 carbon atoms, R2 is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

The second fluid as described generally functions as a diverting agent and promotes the re-direction of the subsequent stage or stages of fluids to another region of the wellbore, further contributing to improving the quality of the wellbore treatment. In a matrix treatment, the first and second fluids in this configuration are pumped below the fracturing pressure of the formation to avoid fracturing the formation since the objective is a matrix treatment; following the first treatment fluid, the second treatment fluid is pumped down to create a diverting plug in the near wellbore area; another step of pumping the first treatment fluid will be achieved to treat the rock in another location and subsequent operations will be repeated in order to maximize the wellbore coverage and efficiency. Once the matrix treatment operations are finished, the acid precursor material in the wellbore plug will degrade thus releasing the acid and assist cleanup of the near wellbore area thus improving the conductivity.

In some embodiments the second fluid is not acidic to avoid damage to the near wellbore area and/or premature restoration of conductivity in the plugged zone; indeed, the first fluid that is used may need time to effect treatment, e.g., acidization in the case of matrix acidizing, or resin curing in the case of consolidating treatments, and the near wellbore area being “plugged” will enable this phenomenon. When the downhole conditions trigger the degradation of the acid precursor material, the flowback of the first treatment fluid in conjunction with the degradation of the acid precursors in the non-acidic treatment fluid (second fluid) will clean the near wellbore area thus maximizing the conductivity.

Methods of wellsite and downhole delivery of the composition are the same or similar as for existing particulate diverting materials. Typically such particulate materials are introduced in the pumping fluid and then displaced into the near wellbore region as described herein. The list of injecting equipment may include various dry additive systems, flow-through blenders etc. In one embodiment the blends of particles may be batch mixed and then introduced into the treating fluid in slurried form.

### Compositions

Even if the first and second fluids have specific features to achieve their goals, some of the chemicals involved in both fluid may share similar properties. Material that can be used indifferently in both treatment fluid will be disclosed here after.

In some embodiments, Both treatment fluids may optionally further comprise additional additives, including, but not limited to fluid loss control additives, gas, foaming agents, stabilizers, corrosion inhibitors, scale inhibitors, catalysts, clay control agents, biocides, friction reducers, combinations thereof and the like. For example, in some embodiments, it may be desired to foam the composition using a gas, such as air, nitrogen, or carbon dioxide.

The compounded material(s) may further include a plasticizer, nucleation agent, flame retardant, antioxidant agent, or desiccant.

Even if the disclosure was mostly directed towards cased hole treatment, the present technology is equally applicable to open hole treatments.

To facilitate a better understanding, the following examples of embodiments are given. In no way should the following examples be read to limit, or define, the scope of the overall disclosure.

### EXAMPLES

### Example 1

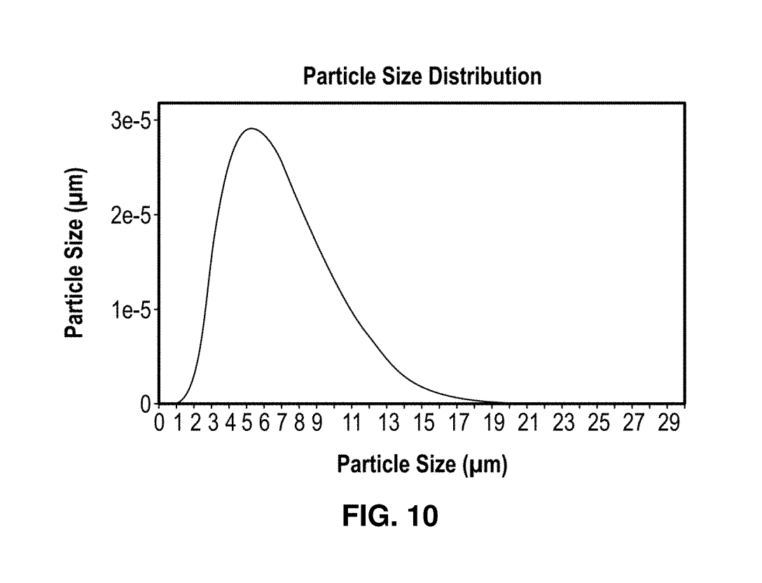

Acid precursor particles comprising PLA and having an average particle size of 5 microns were evaluated for particle size distribution using a Coulter counter. FIG. 10 is a particle size distribution diagram for acid precursor diversion particles that can be suitably employed according to some embodiments of the disclosure. The diagram shows a particle size distribution mode of 5-6 microns that is sufficiently small to be supplied to a zone in the formation through coiled tubing, screen, gravel pack, etc. to form a diverter plug.

### Example 2

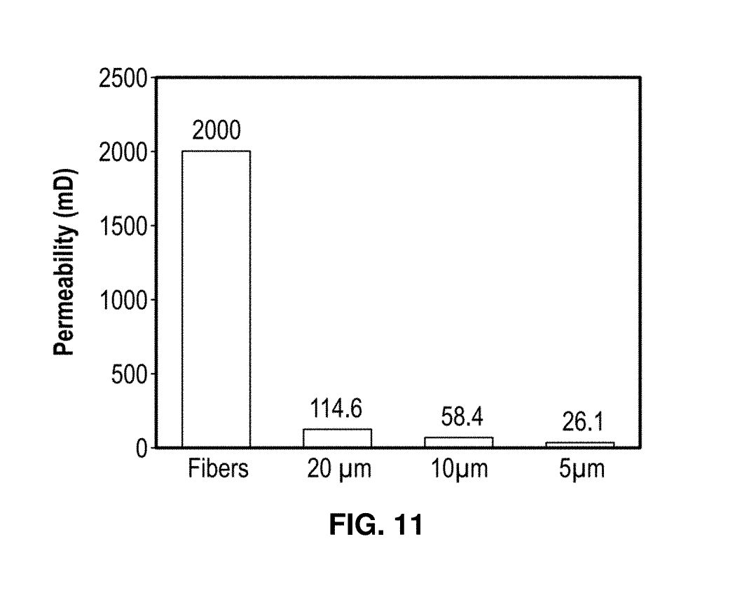

FIG. 11 is a graph comparing the permeability of some examples of fibers and the acid precursor particulates that can be suitably used in methods according to some embodiments of the present disclosure. The permeability of the fibers alone is 2000 mD, whereas that of the acid precursor particles having an average size of 20 microns is 114.6 mD, 10-micron acid precursor particles 58.4 mD, and the 5-micron acid precursor particles (Example 1) 26.1 mD.

### Example 3

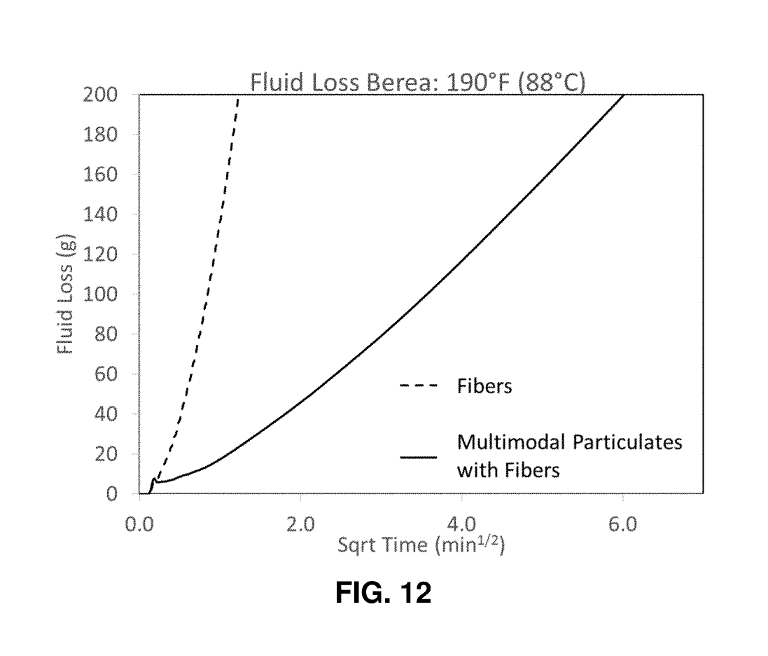

A multimodal blend of PLA (150 ppt) was mixed with 25 ppt of fibers and tested in a fluid loss cell. The fluid loss performance was compared to a sample containing fibers alone. FIG. 12 is a graph comparing the fluid loss performance of the multimodal PLA blend with a fiber sample on approximately 500 mD Berea sandstone cores in the fluid loss cell at 88° C. (190° F.). Fluid loss was much better (reduced) for the acid precursor particles.

### Example 4

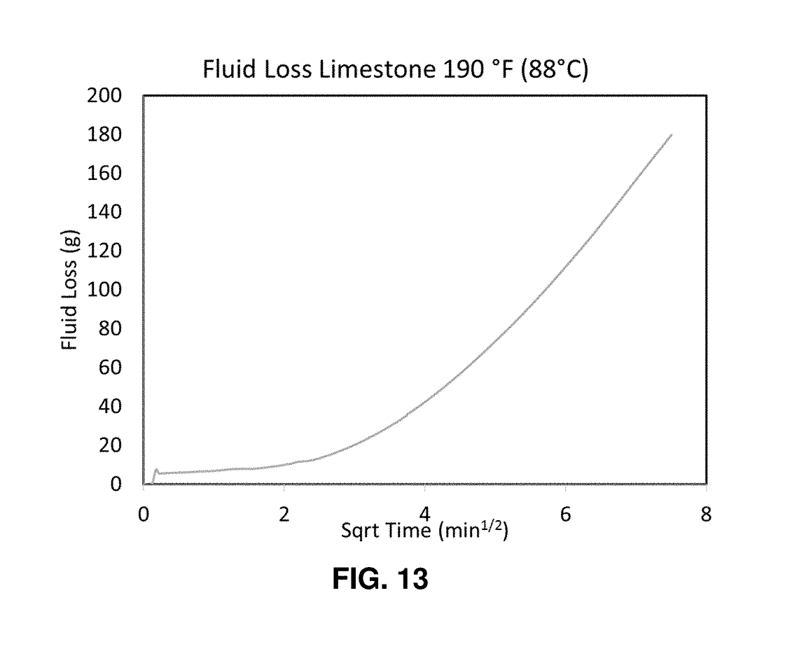

A sample of 5 μm of PLA (from Example 1) was also tested in a slurry at 930 ppt in the fluid loss cell of Example 3 with a 70 mD Indiana limestone core at 88° C. (190° F.). As seen in FIG. 13, the particles showed similar fluid loss performance to the multimodal mixture in Example 3. The core from this test following treatment with the particles was heated in brine for a period of time at 93° C. (200° F.) and the core was then tested for regained permeability. A similar fluid loss test was performed at 121° C. (250° F.) and the core was heated in the same fashion. The permeability results of these tests are presented in the following table:

| | Initial | Regained Perm |
|---|---|---|
| Temperature | Perm (mD) | After Heating (mD) |
| 88° C. (190° F.) | 31 | 52 |
| 121° C. (250° F.) | 138 | 198 |

In both cases, heating the core after the fluid loss test improved the permeability, thought to be the result of the acid release from the particles and reaction with the limestone core material.

The foregoing disclosure and description is illustrative and explanatory, and it can be readily appreciated by those skilled in the art that various changes in the size, shape and materials, as well as in the details of the illustrated construction or combinations of the elements described herein can be made without departing from the spirit of the disclosure.

What is claimed is:

1. A method to treat formation damage or other service induced damage in a near wellbore region or damage to the formation adjacent to the near wellbore, or both, of a wellbore, comprising:
placing a first amount of a first acid precursor material in the near wellbore region to form a diverting barrier and selectively reduce hydraulic conductivity between a first zone and the wellbore, the first acid precursor having a first average particle size of about 1000 microns or less;
pumping a first amount of a treatment fluid into the wellbore;
diverting the first amount of the treatment fluid from the first zone to a zone other than the first zone of the near wellbore region;
at least partially removing damage from the zone other than the first zone of the near wellbore region or damage to the formation adjacent to the near wellbore region of the zone other than the first zone, or both; and
at least partially restoring the hydraulic conductivity between the first zone and the wellbore through at least the partial removal of the diverting barrier.

2. The method of claim 1 wherein, prior to placing the first amount of the first acid precursor material in the near wellbore region:
pumping a second amount of the treatment fluid into the wellbore; and
at least partially removing damage from the first zone of the near wellbore region or damage to the formation adjacent to the near wellbore region of the first zone, or both.

3. The method of claim 1, wherein the placement of the first acid precursor material comprises pumping a slurry comprising the first acid precursor material.

4. The method of claim 2, further comprising deploying a coiled tubing assembly in the well and wherein placing the first amount of the first acid precursor material comprises pumping a slurry comprising the first acid precursor material through a flow path defined by the coiled tubing.

5. The method of claim 4, wherein deploying a coiled tubing assembly comprises deploying a coiled tubing assembly having a fiber optic tether disposed in the flow path of the coiled tubing and further comprising taking distributed measurements from the fiber optic tether during one or more of:
i) the pumping of the first amount of the treatment fluid,
ii) the pumping of the second amount of the treatment fluid,
iii) the pumping of the slurry,
iv) the diversion of the second amount of the first treatment fluid, and
v) the at least partial restoring of the hydraulic conductivity between the first zone and the wellbore through at least the partial removal of the diverting barrier, to observe the behavior of the treatment fluids placed in the near wellbore region.

6. The method of claim 1, further comprising pumping the first amount of the first acid precursor material through a screen, a gravel pack, a sleeve, an ICD or a combination thereof.

7. The method of claim 1, wherein the first acid precursor material has a multimodal particle size distribution.

8. The method of claim 1, wherein fibers are also placed in the near wellbore region to join the first amount of the first acid precursor material to form the diverting barrier.

9. The method of claim 8 wherein the fibers and the first amount of the first acid precursor material are placed into the near wellbore region simultaneously with the first amount of the treatment fluid.

10. The method of claim 8, wherein the placement of the fibers and the first acid precursor material comprises pumping a treatment stage comprising alternating slugs of a first slurry comprising the first acid precursor material alternated with a second slurry comprising the fibers.

11. The method of claim 8, wherein the fibers are present in the slurry at a concentration of from about 1 to 150 ppt.

12. The method of claim 8, wherein the fibers comprise a second acid precursor material selected from the group consisting of polylactic acid, polyglycolic acid, copolymers of lactic and glycolic acids, and combinations thereof.

13. The method of claim 8, wherein the fibers comprise a non-degradable material.

14. The method of claim 1 wherein the first acid precursor material is selected from the group consisting of polylactic acid, polyglycolic acid, copolymers of lactic and glycolic acids, and combinations thereof.

15. A method to treat formation damage or other service induced damage in a near wellbore region or damage to the formation adjacent to the near wellbore, or both, of a wellbore, comprising:
providing a first treatment fluid;
pumping a plurality of stages of the first treatment fluid into the wellbore for contact with a plurality of respective zones of the near wellbore region to at least partially remove damage from the respective zone of the near wellbore region or damage to the formation adjacent to the near wellbore of the respective zone, or both;
providing a second treatment fluid comprising a carrier fluid, an acid precursor material having a first average particle size of about 1000 microns or less;
alternately pumping in the wellbore respective stages of the second treatment fluid between sequentially preceding and subsequent ones of the stages of the first treatment fluid to form diverting barriers to reduce hydraulic conductivity between respective preceding and subsequent ones of the zones and the wellbore;
diverting the subsequent ones of the first treatment fluid stages from a respective preceding zone of the near wellbore region to a respective subsequent zone of the near wellbore region;
after a final stage of the second treatment fluid, pumping a final stage of the first treatment fluid into the wellbore and diverting the final stage of the first treatment fluid to a final one of the zones of the near wellbore region to at least partially remove damage from the final zone of the near wellbore region or damage to the formation adjacent to the near wellbore of the final zone, or both; and
at least partially restoring the hydraulic conductivity between at least one of the plurality of zones and the wellbore through at least the partial removal of at least one of the diverting barriers.

16. The method of claim 15, further comprising deploying a coiled tubing assembly in the well and wherein the second treatment fluid is pumped through a flow path defined by the coiled tubing.

17. The method of claim 16, wherein deploying a coiled tubing assembly comprises deploying a coiled tubing assembly having a fiber optic tether disposed in the flow path of the coiled tubing and further comprising taking measurements from a fiber optic tether during one or more of:
i) the pumping of a plurality of stages of the first treatment fluid,
ii) the pumping of the respective stages of the second treatment fluid,
iii) the diverting of the subsequent ones of the first treatment fluid stages, and
iv) the at least partial restoring of the hydraulic conductivity between at least one of the plurality of zones and the wellbore through at least the partial removal of at least one of the diverting barriers, to observe the behavior of the first and second treatment fluids placed in the near wellbore region.

18. The method of claim 15, wherein the first acid precursor material has a multimodal particle size distribution.

19. The method of claim 15 wherein the first acid precursor material is selected from the group consisting of polylactic acid, polyglycolic acid, copolymers of lactic and glycolic acids, and combinations thereof.

20. The method of claim 15, wherein the second treatment fluid further comprises fibers.
